(19) United States
(12) Patent Application Publication
(10) Pub. No.: US 2009/0295108 A1
(43) Pub. Date: Dec. 3, 2009

(54) Mobile Ball Hopper and Sport Bag Carrier

(76) Inventor: Albert Hisayuki Oku, Covina, CA (US)

Correspondence Address: QUICKPATENTS, INC., 32861 CALLE PERFECTO, SUITE A, SAN JUAN CAPISTRANO, CA, 92675, US

(21) Appl. No.: 12/125,835

(22) Filed: May 22, 2008

(51) Int. Cl. B62B 3/02

(52) U.S. Cl. 280/43

(57) ABSTRACT

A carrier for sporting equipment is disclosed that includes a hopper that has an outer peripheral flange and defines a volume for receiving the sporting equipment therein. A hopper supporting means comprise an adjustable peripheral support and a plurality of height-adjustable legs. Each leg has an upper end fixed to the peripheral support at a band attachment means thereof, and a lower end that terminates at a wheel assembly. A lid may be included for covering the hopper and for providing a substantially horizontal surface. Preferably the adjustable peripheral support comprises a resilient band that has an adjustment hand crank attached therealong for adjusting the size of an aperture formed by the band. Each leg is preferably telescoping and further includes a locking means for selectively fixing the height of the leg.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to sporting goods, and more particularly to a novel sporting equipment carrier.

### DISCUSSION OF RELATED ART

Sporting equipment carriers for use on the tennis court or sporting field are well known in the prior art. Such devices typically take the form of a rolling bin or cart into which the sporting equipment may be stowed and transported. Certain drawbacks exist with the prior art, however. For example, users of such devices may have bins for holding the sporting equipment that is of varying sizes, so having a base that is adaptable to varying-sized bins would be advantageous. Devices such as that disclosed in U.S. Pat. No. 6,179,306 to Maxwell on Jan. 30, 2001, teach a rolling base for a bin that is of a fixed size. Further, such a device does not allow for height adjustment, which is desirable for accommodating users of varying heights.

Similarly, U.S. Pat. No. 6,543,800 to Doran on Apr. 8, 2003, teach an equipment carrier that is pulled along the ground and is generally too low to practically carry tennis balls and keep them within easy reach during practice, such as while practicing serving, for example. The user of such a device would have to bend down each time to grab the next ball, and this type of device makes no provision for adjusting the height of the tennis balls stored therein.

U.S. Pat. No. 6,666,465 to Chan on Dec. 23, 2003, teaches a device for holding gardening implements. Such a device suffers the drawback that the base for supporting the bin cannot be easily adapted for bins of varying diameters.

Further absent in the prior art is a device that can provide an easy means for locking a lid over the bin to prevent theft of the sporting equipment when the device is not in use. Further, such a needed device would be easily adjusted to a variety of shapes of bins so as to be useful with pre-existing ball or equipment bins. Such a needed device would also provide at least one horizontal area for holding duffle bags, tennis racquet covers, or the like. Further, such a needed invention would provide a means for easily stowing the bin cover temporarily while the device is in use. Such a needed device would be easily collapsed or disassembled for transport and storage, and would be relatively easy to set-up again. The present invention accomplishes these objectives.

### SUMMARY OF THE INVENTION

The present device is a carrier for sporting equipment that includes a hopper that has an outer peripheral flange and defines a volume for receiving the sporting equipment therein. A hopper supporting means comprise an adjustable peripheral support and a plurality of height-adjustable legs. Each leg has an upper end fixed to the peripheral support at a band attachment means thereof, and a lower end that terminates at a wheel assembly. The hopper may further include at least one handle, preferably U-shaped and fixed to a top surface of the peripheral flange thereof. A lid may be included for covering the hopper and for providing a substantially horizontal surface. The lid may further include at least one handle aperture therethrough and aligned with each handle of the hopper.

Preferably the adjustable peripheral support comprises a resilient band that has an adjustment hand crank attached therealong for adjusting the size of an aperture formed by the band. As such, hoppers of varying sizes may be supported by the supporting means.

Each leg is preferably telescoping and further includes a locking means, such as a cam lock for selectively fixing the height of the leg. Each leg may further include a selectively adjustable and lockable lower pivot for adjusting the angle of the wheel assembly thereof with respect to the leg. Likewise, each leg may further include a selectively adjustable and lockable upper pivot for adjusting the angle of the band attachment means thereof with respect to the leg. As such, varying types of hoppers may be utilized with the carrier, and each wheel assembly may be pivoted up and away from the ground surface so that the carrier will remain stationary on the ground surface and will not roll.

The present invention is a device that accommodates various sizes of equipment bins for easy transport to a sporting field or court. The present device further provides an easy means for locking a lid over the bin to prevent theft of the sporting equipment when the device is not in use, the cover thereof serving as a horizontal support surface for other sporting equipment or implements. Further, the present invention is easily adjusted to a variety of shapes of bins so as to be useful with pre-existing ball or equipment bins. Further, the present invention provides a means for easily stowing the bin cover temporarily while the device is in use. Moreover, the present device may be easily assembled and disassembled for convenient transport and storage. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective elevation view of a mobile ball hopper and sport bag carrier of the invention in use;

FIG. 2 is a perspective elevation view of a supporting frame;

FIG. 3 is a perspective elevation view of a basket;

FIG. 4 is a detailed perspective elevation view of a cover; and

FIG. 5 is an exploded elevation view of the device.

### DETAILED DESCRIPTION OF THE PREFERRED EMBODIMENT

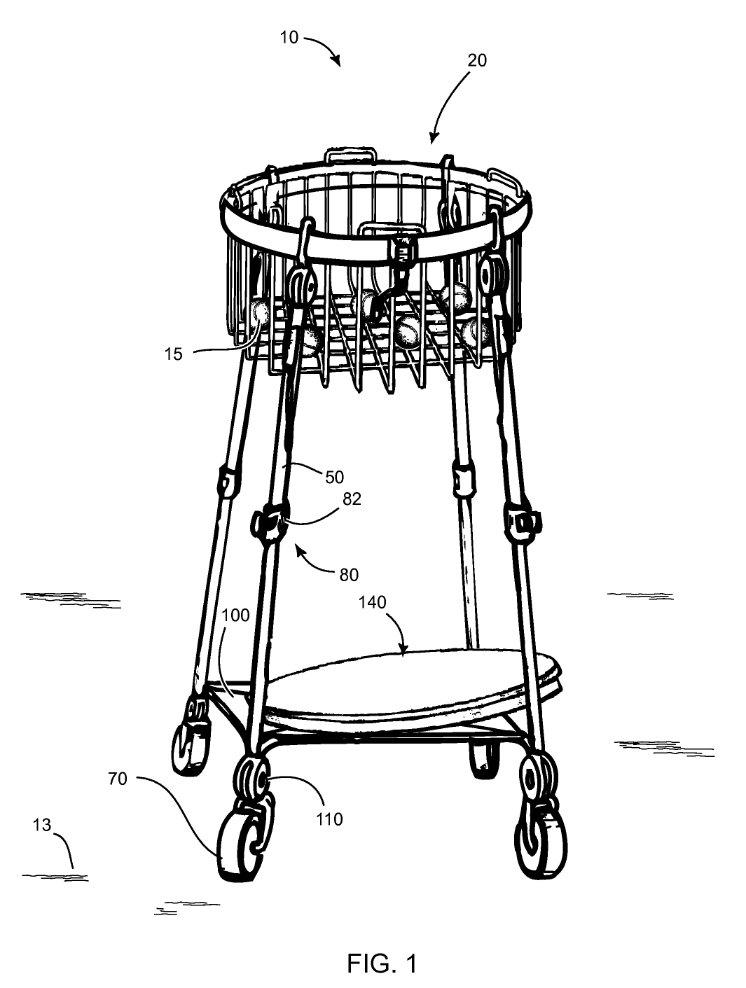

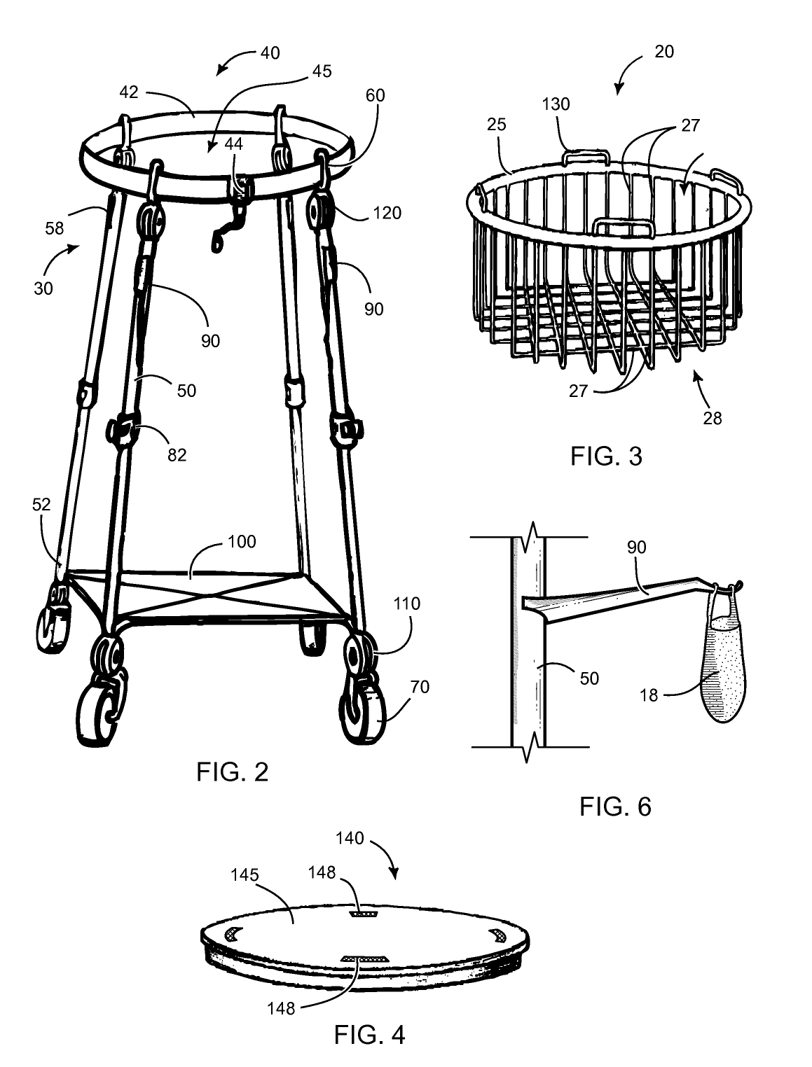

FIGS. 1 and 2 illustrate a carrier 10 for sporting equipment 15, such as tennis balls, golf balls, or other sporting balls, pucks, birdies, or other equipment. The carrier 10 includes a hopper 20 that has an outer peripheral flange 25 and defines a volume 28 for receiving the sporting equipment therein (FIG. 3). Such a hopper 20 may be formed from a plurality of bent metal wire 27 to form a hopper basket 28, for example. The hopper 20 may also be a molded plastic bucket, a formed sheet metal bucket, a perforated metal bucket, or the like (not illustrated). Preferably the hopper 20 is circular in plan view, although other hopper 20 shapes could be utilized as desired.

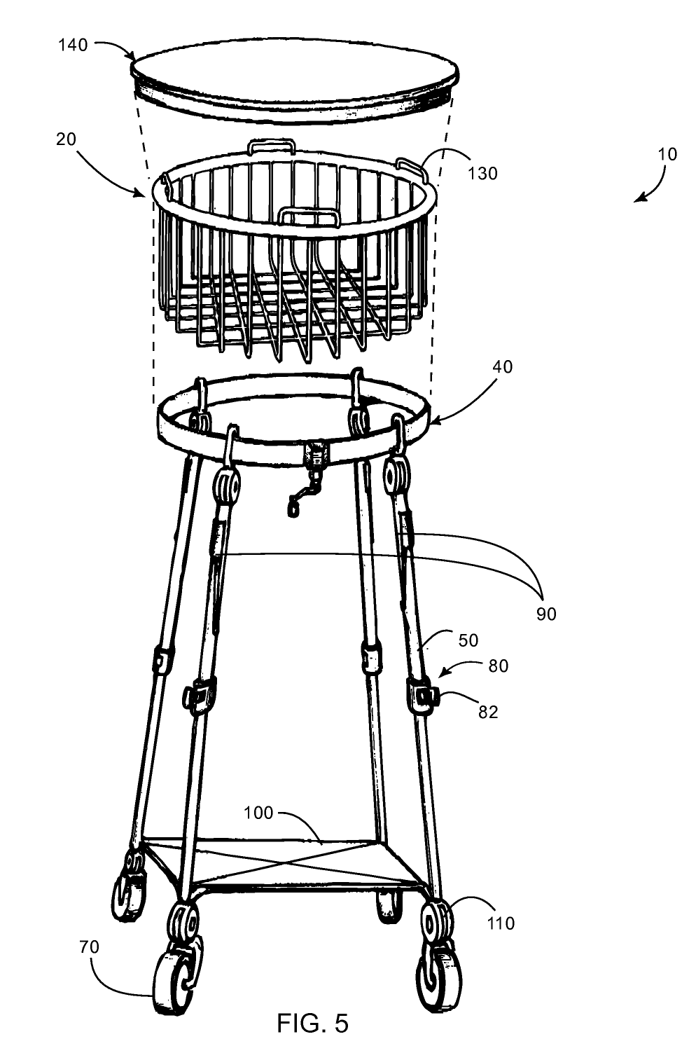

A hopper supporting means 30 comprise an adjustable peripheral support 40 and a plurality of height-adjustable legs 50. Each leg 50 has an upper end 58 fixed to the peripheral support 40 at a band attachment means 60 thereof. Each leg 50 further includes a lower end 52 that terminates at a wheel assembly 70 (FIG. 5). The lower end 52 of each leg 50 is fixedly attached to its immediately adjacent legs 50, and preferably include a base surface 100 fixed thereto for carrying additional sporting equipment 15, such as tennis racquets, golf clubs, water coolers, or the like. The base surface 100 may be made form a wire mesh, a rigid metal, plastic, or wood material, for example. The hopper 20 may further include at least one handle 130, preferably U-shaped and fixed to a top surface of the peripheral flange 25 thereof (FIG. 3). In this fashion, multiple hoppers 20 of varying sizes may be accommodated by the hopper support means 30.

A lid 140 may be included for covering the hopper 20 and for providing a substantially horizontal surface 145 (FIGS. 4 and 5). The lid 140 may further include at least one handle aperture 148 therethrough and aligned with each handle 130 of the hopper 20. As such, when the lid 140 is covering the hopper 20 each handle 130 of the hopper 20 projects through one handle aperture 148 of the lid 140. A lock or locking cable (not show) may then be introduced through each handle 130 to lock the lid 140 down over the hopper 20, so as to prevent theft of the sporting equipment 15, for example. Preferably the lid 140 is sized to fit on the base surface 100 to facility temporary storage thereof.

Preferably the adjustable peripheral support 40 comprises a metallic or plastic resilient band 42, or the like, that has an adjustment hand crank 44 attached therealong for adjusting the size of an aperture 45 formed by the band 42 (FIG. 2). As such, hoppers 20 of varying sizes may be supported by the supporting means 30.

Each leg 50 is preferably telescoping and further includes a locking means 80, such as a cam lock 82 (FIG. 2), as is known in the art, for selectively fixing the height of the leg 50. At least one leg 50 further includes a bag support arm 90 that is pivotally fixed thereto and adapted to hold an equipment bag 18 suspected above a ground surface 13 (FIG. 6). Such an equipment bag 18 may be, for example, a bag of tennis balls, dry towels, or the like (not shown). In an embodiment having two such bag support arms 90, the bag 18 may be suspended across each support arm 90 (not shown).

Each leg 50 may further include a selectively adjustable and lockable lower pivot 110 for adjusting the angle of the wheel assembly 70 thereof with respect to the leg 50. Likewise, each leg may further include a selectively adjustable and lockable upper pivot 120 for adjusting the angle of the band attachment means 60 thereof with respect to the leg 50. As such, varying types of hoppers 20 may be utilized with the carrier 10, and each wheel assembly 70 may be pivoted up and away from the ground surface 13 so that the carrier 10 will remain stationary on the ground surface 13 and will not roll.

Preferably each leg 50 may be selectively detached from the other components so that the carrier 10 may be easily disassembled and reassembled for convenient transport and storage thereof.

While a particular form of the invention has been illustrated and described, it will be apparent that various modifications can be made without departing from the spirit and scope of the invention. For example, various means of telescoping legs 50 may be utilized as is known in the art, not just the cam lock 82 shown in the illustrations. Accordingly, it is not intended that the invention be limited, except as by the appended claims.

What is claimed is:

1. A carrier for sporting equipment, comprising:
a hopper having an outer peripheral flange, the hopper defining a volume for receiving the sporting equipment therein;
a hopper supporting means comprising an adjustable peripheral support and a plurality of height-adjustable legs, each leg having an upper end fixed to the peripheral support at a band attachment means thereof, and a lower end terminating at a wheel assembly, the lower end of each leg fixedly attached to its immediately adjacent legs.

2. The carrier of claim 1 wherein the adjustable peripheral support comprises a resilient band and an adjustment hand crank for adjusting the size of an aperture formed by the band.

3. The carrier of claim 1 wherein each leg is telescoping and further includes a locking means for fixing the height of the leg.

4. The carrier of claim 3 wherein the locking means is a cam lock.

5. The carrier of claim 1 further including at least one bag support arm, each pivotally fixed to one of the legs and adapted to hold an equipment bag suspended above a ground surface.

6. The carrier of claim 1 wherein a base surface is fixed to each leg proximate the lower end thereof.

7. The carrier of claim 1 wherein each leg further includes an adjustable and lockable lower pivot for adjusting the angle of the wheel assembly thereof with respect to the leg.

8. The carrier of claim 1 wherein each leg further includes an adjustable and lockable upper pivot for adjusting the angle of the band attachment means thereof with respect to the leg.

9. The carrier of claim 1 wherein the hopper is formed from a plurality of bent metal wire to form a hopper basket.

10. The carrier of claim 1 wherein the hopper further includes at least one handle fixed to the peripheral flange thereof.

11. The carrier of claim 1 further including a lid for covering the hopper and providing a substantially horizontal surface.

12. The carrier of claim 10 further including a lid for covering the hopper and providing a substantially horizontal surface, the lid further includes at least one handle aperture therethrough and aligned with each handle of the hopper, such that when the lid is covering the hopper each handle of the hopper projects through one handle aperture of the lid.

13. The carrier of claim 1 wherein the peripheral flange of the hopper is circular in plan view.

14. The carrier of claim 6 wherein the lid is sized to be supporting flat on the base surface.
